(19) United States
(12) Patent Application Publication
(10) Pub. No.: US 2006/0143649 A1
(43) Pub. Date: Jun. 29, 2006

(54) Method and system of digital advertising

(75) Inventors: Mark W. Laney, Littleton, CO (US); Paul D. Woidke, South Orange, NJ (US)

Correspondence Address: BROOKS KUSHMAN P.C., 1000 TOWN CENTER, TWENTY-SECOND FLOOR, SOUTHFIELD, MI, 48075, US

(73) Assignee: Comcast Cable Holdings, LLC, Philadelphia, PA (US)

(21) Appl. No.: 11/025,313

(22) Filed: Dec. 29, 2004

(51) Int. Cl. H04N 7/10; G06Q 30/00; H04N 7/025

(52) U.S. Cl. 725/32; 705/14

(57) ABSTRACT

Method and system of digital advertising. The method and system relating to digital advertising with a number of modules operating according to an open-interface protocol such that multiple modules may be provided by different vendors in a multi-vendor environment.

### BACKGROUND OF THE INVENTION

1. Field of the Invention

The present invention relates to methods and system of digital advertising.

2. Background Art

Cable system architectures are closed systems in that modules and other features provided by one vendor typically are incompatible with modules and features provided by other vendors. As such, the ability to change modules to those of new vendors is limited unless the cable system provider is willing to change all the modules in the system or pay for costly patches to integrate the new vendor modules with the existing modules.

With the advent of digital advertising, more vendors are developing modules that are useful in performing functions related to advertising. The ability to integrate the modules of such vendors is limited due to restraints of existing cable architectures. This is a problem because it limits the ability of cable system providers to take advantage of potential benefits provided with the newer modules of the developing vendors.

As such, a need exits for a cable system architecture that overcomes the above-identified deficiencies of the prior art.

### SUMMARY OF THE INVENTION

One non-limiting aspect of the present invention relates to a system of digital advertising that includes a number of modules operating according to an open-interface protocol so as to permit modules from different vendors to be used together.

In accordance with one non-limiting aspect of the present invention, the modules are included within an advertising system configured for operation at a headend unit and to direct the insertion and playback of digital advertisements.

In accordance with one non-limiting aspect of the present invention, the advertising system may include a control plane, a data plane, and a management plane each having a number of modules configured to operate according to the open-interface protocol. In particular, the control plane may include modules for providing services to subscribers, the data plane may include modules for storing digital advertisements for playback, and the management plane may include modules for directing the insertion of digital advertisements from the data plane into the services provided by the control plane.

In accordance with one non-limiting aspect of the present invention, the control plane may include an analog video module, an edge devices module, a digital video recorder (DVR) module, a video on demand (VOD) module, a telephony module, a digital video module, and an interactive services module.

In accordance with one non-limiting aspect of the present invention, the management plane may include a content and asset module, a profile module, a campaign module, an insertion module, a user input and output module, and a targeting module.

In accordance with one non-limiting aspect of the present invention, the data plane may include a data storage module, a privacy module, a billing module, a transaction module, and a reporting and fulfillment module.

The above features and advantages, along with other features and advantages of the present invention, are readily apparent from the following detailed description of the invention when taken in connection with the accompanying drawings.

### BRIEF DESCRIPTION OF THE DRAWINGS

FIG. 1 illustrates a cable system in accordance with one non-limiting aspect of the present invention; and

FIG. 2 illustrates a digital advertising system in accordance with one non-limiting aspect of the present invention.

### DETAILED DESCRIPTION OF THE PREFERRED EMBODIMENT(S)

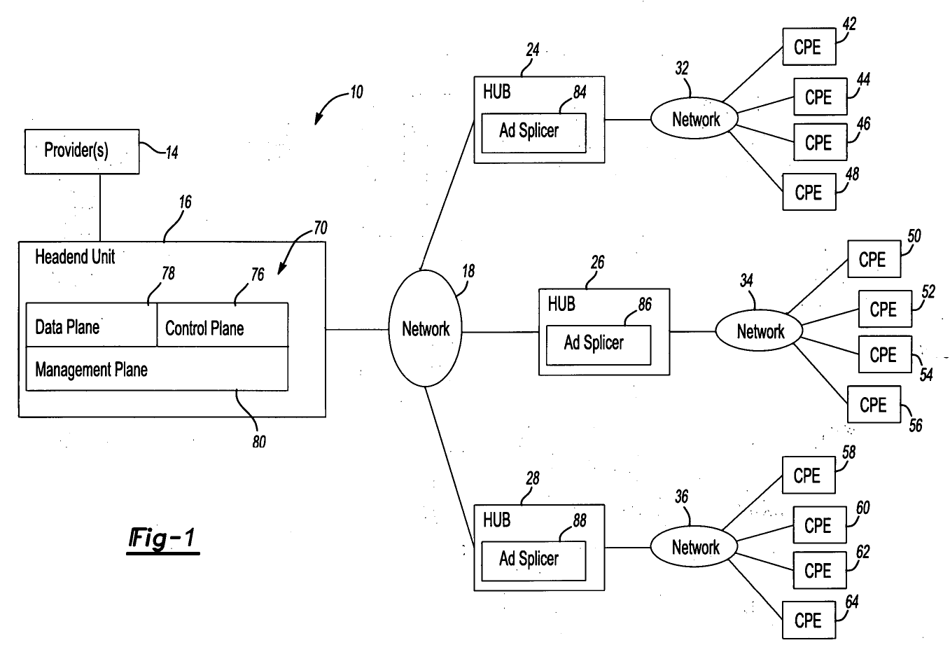

FIG. 1 illustrates a cable system 10 in accordance with one non-limiting aspect of the present invention. The cable system 10 may include one or more content providers 14, a headend unit 16, a regional network 18, a number of hubs 24-28, a number of local networks 32-36, and a number of pieces of customer premises equipment (CPE) 42-64.

In general, the headend unit 16 is a regional or national unit configured to provide media services, such as Internet services, television programs, movies, and other features to its subscribers. The subscribers access these services through one or more pieces of CPE 42-64. The CPE 42-64 may include any number of items, such as set-top box (STB) units, cable modem units, embedded cable units (such as cablecards), voice over internet protocol (VoIP) telephone units, digital video recorders (DVRs), personal video recorders (PVRs), and the like.

The media services provided to the subscribers are shown as being communicated to the headend unit 16 from one or more service providers 14 and transmitted therefrom over the regional network 18 to one or more hubs 24-28, which then deliver the media signals to the pieces of CPE 42-64 over local networks 32-36. The regional and local networks 18, 32-36 may comprise any type of network constructions, such as hybrid fiber cable, coaxial cable, public telephone switching networks (PSTN), wireless networks, satellite networks, and the like, and the present invention is not intended to be limited to any particular network or communication medium.

As shown, a single headend unit 16 supports the local networks 32-36 and the CPE 42-64 associate therewith. The present invention, however, is not limited to single headend environments and contemplates systems where multiple headend units may service multiple pieces of CPE through regional and/or local networks. The system 10 is intended to generally refer to any cable system wherein content providers of Internet services, television programs, movies, and other features provide media signals, including audio, video, and data, to CPE 42-64. As such, the present invention contemplates that the system 10 may include more or less of these features and is not intended to be limited to the foregoing.

In accordance with one non-limiting aspect of the present invention, the headend unit 16 may include an advertising system 70 configured to provide digital advertisements to the CPE 42-64. In more detail, the system 70 may be configured to output digital advertisements in manner that the advertisements may be delivered through digital routers, switches, and other communication mediums in the headend 16, networks 18, 32-36, hubs 24-28, and CPE 42-64 to control, display, and otherwise manipulate the advertisements.

In more detail, the advertisements, including any audio, media, and data signals associated therewith, may be packetized for deliver according to Transmission Control Protocol (TCP) and the Internet Protocol (IP), commonly referred to as TCP/IP, Open Systems Interconnection (OSI) Reference Model, and others, as one having ordinary skill in the art will appreciate. Moreover, the advertisements may be compressed and otherwise manipulated for digital transport, such as according to Moving Picture Experts Group (MPEG) and the like.

Of course, however, the present invention, as described above, is not intended to be limited to digital only systems. Rather, the present invention contemplates that the system 10 may include analog features and the like, including features having capabilities to support both analog and digital transmissions and protocols. In particular, the present invention contemplates that the digital advertising system 70 may be integrated into existing analog headend units and other similar systems for inserting digital advertisements, such as by converting the digital advertisements to analog advertisements. Likewise, however, the present invention contemplates that the advertising system may be integrated with or a standalone feature in an all digital environment.

In accordance with one non-limiting aspect of the present invention, the advertising system 70 may include a control plane 76, a data plane 78, and a management plane 80 to control the inserting, playback, and delivery of advertisements to the CPE 42-64. The planes are intended to refer to logical data segments, features, and other software and hardware groups configured to manipulate, program, transmit, and otherwise direct delivery and execution of function elements, steps, logic, and control. As such, the planes may include other features which are not shown, such as memories, processors, servers, and the like.

In general, the control plane 76, management plane 80, and data plane 78 provide the advertisements to the CPE 42-64. The operation thereof, as described below in more detail, may be integrated into other headend operations. In accordance with one non-limiting aspect of the present invention, the advertisements are delivered from the headend unit 16 with digital media streaming and/or separately to a number of ad splicers 84-88 located on the number of hubs 32-36 so that the ad splicers 84-88 may then add the advertisements to the services provided to the CPE 42-64. In accordance with one non-limiting aspect of the present invention, the ad splicers 84-88 are regionally associated with the regional networks 24-28 so that advertisements may be assigned to different regions, such as to support regional advertising by controlling the ad splicers 84-88 to capture digital advertisements circulating on the network 18 for delivery to their associated regional network 32-36.

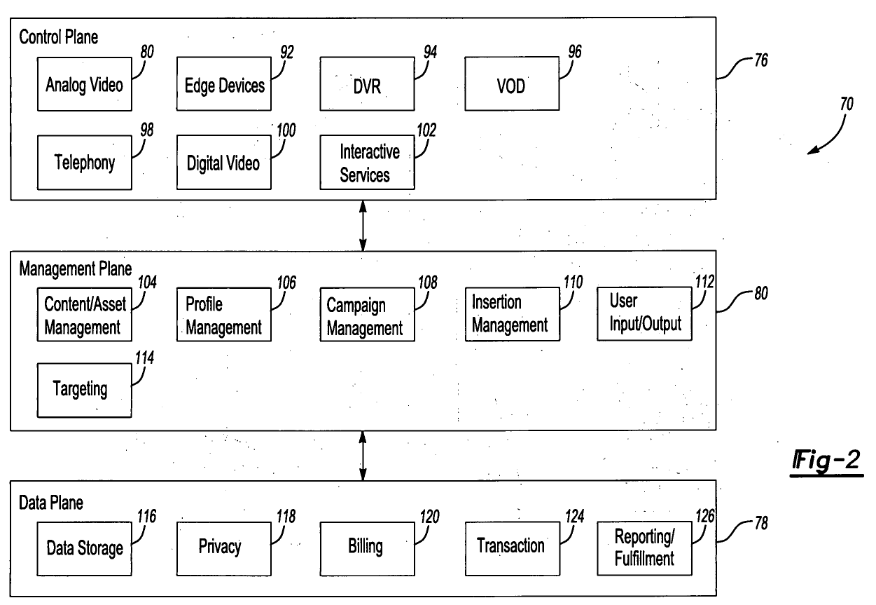

FIG. 2 illustrates the advertising system 70 in accordance with one aspect of the present invention. The system 70 preferably includes a number of modules 90-126 associated with each plane 76-80 to perform functions relating to varying aspect of digital advertising of the present invention.

The modules 90-126 are functional groups of software, logic, hardware, and the like for manipulating, controlling, delivering, and performing a variety of operations. In accordance with one non-limiting aspect of the present invention, each module 90-126 is configured to operate according to an open-interface. The open-interface is preferably a standard communication protocol that permits the transmission of data and other signals between the modules in formats that are understood by each module in each plane. In accordance with one non-limiting aspect of the present invention, the open-interface may cover only inter-modular communication such that each module 90-126 is permitted to operate according to any user defined, proprietary, or vendor specific protocol.

The use of the open-interface of the present invention allows the advertising system 70 to take advantage of modules 90-126 provided by any number of vendors. This is advantageous because some vendors provide better modules and services than other vendors. As such, rather than requiring each plane or the entire advertising system to be limited to a single vendor, the present invention is able to capitalize on the strengths of each vendor and provide a multi-vendor environment.

The present invention contemplates the advertising system 70 including any number of modules from any number of vendors, including an analog video module 90, an edge devices module 92, a digital video recorder (DVR) module 94, a video on demand (VOD) module 96, a telephony module 98, a digital video module 100, an interactive services module 102, a content and asset module 104, a profile module 106, a campaign module 108, an insertion module 110, a user input and output module 112, a targeting module 114, a data storage module 116, a privacy module 118, a billing module 120, a transaction module 124, and a reporting and fulfillment module 126. Of course, the present invention is not intended to be limited to the foregoing modules and contemplates the use of more or less of these modules and the use of other modules not specified above.

In accordance with one non-limiting aspect of the present invention, the management plane 80 controls interaction of the modules 90-126 of each plane 76-80, such as to control insertion of advertisements stored in the data plane 78 into applications accessible through the control plane 76. The present invention, however, is not limited to the management plane 80 controlling interaction and communication between the modules 90-126. Rather, the present invention contemplates that each module 90-126 may have capabilities to separately communication with each other and without the assistance of the management plane 80 or the modules 104-114 associated therewith.

In accordance with one non-limiting aspect of the present invention, the control plane 76 generally relates to modules 90-102 configured to provide services to the CPE 42-64. The services may include and number of services and may require the modules 90-102 to interact with analog and digital hardware and software of the headend unit 16 and elsewhere in the system to provide such services to the CPE 42-64.

The control plane 76 is shown to include the analog video module 90, the edge devices module 92, the DVR module 94, the VOD module 96, the telephony module 98, the digital video module 100, and the interactive services module 102. As described above, the present invention is not limited to this exemplary configuration and contemplates more or less of these features and other features.

In more detail, the analog module 90 may be configured for providing analog video to one or more pieces of CPE 42-64 and to insert digital advertisements into the playback of the analog video according to instructions received from the management plane 80 and video stored by the data plane 78, which may require the conversion of digitally stored advertisements to analog advertisements. The inclusion of advertisements in analog delivered services may require the use of q-tones or other features to instruct the analog video module as to when advertisements should be inserted. As such, these and other features are contemplated by the present invention.

The edge devices module 92 may be configured to instruct edges devices in the regional network 18 or local networks 32-36 as to which digital advertisements transported over the networks 18, 32-36 are to be relayed or otherwise communicate from the network 18, 32-36 to another device. For example, the regional networks 32-36 may include one or more edge devices to provide information to the hubs for selecting digital advertisements from those being streamed or otherwise transported over the network 18.

The DVR module 94 may be configured to provide private video storage accounts for one or more subscribers such that each subscriber may access their video account for on demand viewing of previously stored video and playback of the video on their CPE 42-64. In accordance with one non-limiting aspect of the present invention, the DVR module 94 controls playback of video stored regionally at the headend 16 or the hubs 24-28 and/or playback of video stored locally at the CPE 42-64, which may be a DVR. In accordance with one non-limiting aspect of the present invention, the management plane 80 may control the insertion of advertisements stored on the data plane during the playback of video through the DVR module 94.

The VOD module 96 may be configured for providing one or more subscribers with on demand viewing of previously stored video and playback of the video on their CPE 42-64. In accordance with one non-limiting aspect of the present invention, the VOD module 96 controls playback of video stored regionally at the headend 16 or the hubs 24-28 and/or playback of video stored locally at the CPE 42-64. In accordance with one non-limiting aspect of the present invention, the management plane 80 may control the insertion of advertisements stored on the data plane 78 during the playback of video through the VOD module 96.

The telephony module 98 may be configured for providing telecommunication capabilities to the CPE 42-64, such as for VoIP and the like. In accordance with one non-limiting aspect of the present invention, the telephony module 98 coordinates the operation of telecommunications sessions with the management plane 80 to control insertion of digital advertisements from the data plane 78, such as to interrupt a VoIP video phone session to deliver a digital advertisement, which may include both audio and video components.

The digital module 100 may be configured for providing digital video to one or more pieces of CPE 42-64 and to insert digital advertisements into the playback of the digital video according to instructions received from the management plane 80 and video stored by the data plane 78. The inclusion of advertisements in digital delivered services may require the use of q-tones or other features to instruct the digital video module 100 as to when advertisements should be inserted. As such, these and other features are contemplated by the present invention.

The interactive services module 102 may be configured to provide interactive services, such as interactive television, up-selling, requests for information, games, and other interactive features to the CPE 42-64. In general, the interactive services relate to services whereby subscribers at the CPE 42-64 interact with the interactive service module 102, such as to play video games. For example, the interactive services module 102 may include an up-sell feature whereby digital advertisements are provided to the subscribes such that the subscribers may purchase an advertised product by interacting with menus and other options associated with or included in the advertisement. Likewise, the interactive services module may include a request for information feature whereby requests for information are made to subscribers to provide feedback to the cable service provider, which they may be stored on the data plane 78 for subsequent manipulations. Furthermore, the interactive services need not necessary rely on interactive advertisements, such as the above-described up-sell features. Rather, the interactive service may be interruptible services, such as the playing of games, which may be interrupted by the management plane to insert advertisements through control of interactive service provided with the interactive services module.

In accordance with one non-limiting aspect of the present invention, the data plane 78 generally relates to modules 116-126 configured to store digital advertisements and other date relating to the advertisements, which may relate to any number of services and may require the data plane modules 116-126 to receive data and information from modules 90-1114 in the other planes 76, 80 and to likewise provide requested data and information to the same. The data plane 78 is shown to include the data storage module 116, the privacy module 118, the billing module 120, the transaction module 124, and the reporting and fulfillment module 126. As described above, the present invention is not limited to this exemplary configuration for the data plane 78 and contemplates the use of more or less of these modules and the use of other modules not specified above.

The data storage module 116 may be configured for storing the digital advertisements and other data, such as data collected by any module 90-126 in the system 70. In particular, the data storage module 111 may be configured to receive data from the modules 90-126 and the deliver data thereto according to instructions received according to the open-interface protocol. As such, the operation of the other modules 90-126 may be dependent on data stored on the data storage module 116, such as if one module relies on data stored on the data storage module 116 by another, separate module.

The privacy module 118 may be configured for storing data regarding viewing habits of each subscriber with respect to viewing digital advertisements. In accordance with one non-limiting aspect of the present invention, the privacy module 118 may be controlled by the management plane 80 to monitor viewing habits of subscribers during the playback of digital advertisements, such as by noting whether the subscriber changed channels, interacted with the advertisements (such as in an up-sell interactive advertisement), pulled up an electronic programming guide, selected muting, and other operations or steps that may occur during playback of a digital advertisement.

The billing module 120 may be configured for storing data regarding fees accrued to a provider of the cable system from subscribers actions towards the advertisements. In accordance with one non-limiting aspect of the present invention, the management plane 80 may control the billing module 118 to store date relating to pay-per-view viewing purchases made by a subscriber for a program or movie and to store data relating to audio programs, such as downloaded music or the like, purchases made by the subscriber for an album or other feature advertised in the system.

The transaction module 124 may be configured for storing data regarding frequency of advertisement playback. In accordance with one non-limiting aspect of the present invention, the management plane 80 may control the transaction module 124 to store data each time one or more digital advertisements are played so as to record data for billing purposes, such as to bill the provider of the digital advertisement. This method of transaction billing may be advantageous for any number or reasons and applications, and especially advantageous in billing advertisements for advertisements made during interactive services and other application where the frequency of an advertisement showing is variable in comparison to television program advertising wherein the number and frequency of advertisements are more predictable.

The report and fulfillment module 126 may be configured for compiling data and formatting the compiled data into reports and the like. In accordance with one non-limiting aspect of the present invention, the management module 80 may control the reporting and fulfillment module to collect data from the other modules 90-126 and to compile the data into reports or other outputs, such as for delivery to operators, advertising providers, and the like. For example, the reporting and fulfillment module 126 may be used to compile transaction reports from the transaction data stored with the transaction module so as to provide invoices and other types of reports.

In accordance with one non-limiting aspect of the present invention, the management plane 80 generally relates to modules 104-114 configured to interact between the control of services provided by the control plane 76 and the storage and recordation of the data plane 80 so as to control the insertion and playback of advertisements as well as the collection and recordation of data. In some case, the management plane 80 may be required to direct communication between modules 90-126 of the management plane 80 and one or both of the control plane 76 and data planes 78. For example, the management plane 80 may control the edge devices module 92 to note the number of times a particular digital advertisement is routed through for playback on one of the pieces of CPE 42-64 and to communicate each such transaction to the transaction module 124 for recordation.

The management plane 80 is shown to include the data content and asset management module 104, the profile management module 106, the campaign module 108, the insertion management module 110, the user input and output module 112, and the targeting module 114. As described above, the present invention is not limited to this exemplary configuration for the management plane 80 and contemplates the use of more or less of these modules and the use of other modules not specified above.

The content and asset management module 104 may be configured for selecting advertisements from the data plane 78 for playback. In accordance with one non-limiting aspect of the present invention, the content and asset management module 104 maintains a lookup table or other feature to track the digital advertisements available from the data storage plane 78. In this manner, the content and asset management module 104 may search for digital advertisements or otherwise locate desired advertisements so that the advertisement may be retrieved by other modules, or by the content and asset module 104, for playback.

The profile management module 106 may be configured for associating digital advertisements with groups of subscribers according to predefined subscriber criteria. In accordance with one non-limiting aspect of the present invention, the profile management module may be programmed with the subscriber criteria through the user input and output module 112 such that subscribers matching the criteria are located so that advertisement may be directed to the specified subscribers.

The campaign module 108 may be configured for associating digital advertisements with groups of subscribers according to predefined scheduling criteria. In accordance with one non-limiting aspect of the present invention, the campaign module may 108 be programmed with the scheduling criteria, which may be seasonal description (fall, winter, etc.), times of day (hours, minutes, etc.), calendar dates, holidays, and the like, such that advertisements associated with the scheduling are inserted during the corresponding period.

The insertion module 110 may be configured for scheduling playing of advertisements according to instructions provided by one of the modules 90-126. In accordance with one non-limiting aspect of the present invention, the insertion module 110 operates in conjunction with the other management modules to receive inputs, such as timing and content, for advertisement insertion and outputs signal and other commands to the control plane 76, and optionally directly to the modules therein, to control the insertion of the identified advertisement during the identified period of time.

The targeting module 114 may be configured for specifying particular geographical areas in which identified advertisements are to play. In accordance with one non-limiting aspect of the present invention, the targeting module 114 may be configured to instruct the hubs 24-28 and ad splicers 84-88 in the system as to which one and at which time the digital advertisement streaming or otherwise transported over the network 18 are to be inserted on the local networks 32-36 associated therewith based on their geographical area.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An advertising system for digital advertising in a cable system, the advertising system comprising:
a data plane having a plurality of data modules for storing data regarding digital advertisements;
a control plane having a plurality of control modules for providing digital services to cable system subscribers;
a management plane having a plurality of management modules for managing insertion of digital advertisements; and
wherein the management plane controls interaction of the modules according to an open-interface protocol such that the modules are operable with each other if one or more of the modules are provided by different vendors.

2. The advertising system of claim 1 wherein the management plane inserts digital advertisements into the digital services while the digital services are being accessed by the subscribers.

3. The advertising system of claim 2 wherein the digital advertisements are inserted according to instructions provided by one or more modules of the management plane, wherein the one of more modules of the management plane analyze data from the control plane and data plane to control the insertion of digital advertisements.

4. The advertising system of claim 1 wherein one of the control modules is digital video recording (DVR) module for providing private video storage accounts for one or more subscribers such that each subscriber may access their video account for on demand viewing of previously stored video, the management plane being in communication with the DVR module for inserting digital advertisements during the playback of the digital video with the DVR module.

5. The advertising system of claim 4 wherein DVR module is configured to playback digital video stored at a subscriber location in the cable system.

6. The advertising system of claim 4 wherein the DVR module is configured to playback digital video stored at a headend location in the cable system.

7. The advertising system of claim 1 wherein one of the control modules is a video on demand (VOD) module for providing one or more subscribers with on demand viewing of previously stored video, the management plane being in communication with the VOD module for inserting digital advertisements during the playback of the digital video with the VOD module.

8. The advertising system of claim 1 wherein one of the control modules is a telephony module for providing telecommunication capabilities over a cable communication medium in the cable system, the management plane being in communication with the telephony module for inserting digital advertisements during telecommunications sessions conducted with the VOD module.

9. The advertising system of claim 1 wherein one of the control modules is an interactive applications module for providing interactive services, the management plane being in communication with the interactive applications module for inserting digital advertisements during interactive services conducted with the interactive applications module.

10. The advertising system of claim 1 wherein one of the data modules is a data storage module for storing digital advertisements for playback in the cable system.

11. The advertising system of claim 1 wherein one of the data modules is privacy module for storing data regarding viewing habits of each subscriber with respect to viewing digital advertisements.

12. The advertising system of claim 1 wherein one of the data modules is a billing module for storing data regarding fees accrued to a provider of the cable system from subscribers actions towards the advertisements.

13. The advertising system of claim 1 wherein one of the data modules is a transaction module for storing data regarding frequency of advertisement playback.

14. The advertising system of claim 1 wherein one of the data modules is a report and fulfillment module for compiling data from each module in the data plane and presenting the compiled data to the management module for use in inserting digital advertisements.

15. The advertising system of claim 1 wherein one of the data modules is a targeting module for assigning advertisements to specific geographical areas.

16. The advertising system of claim 1 wherein one of the management modules is a content and asset management module for selecting advertisements from the data plane for playback in the cable system.

17. The advertising system of claim 1 wherein one of the management modules is a profile management module for associating digital advertisements with groups of subscribers according to predefined subscriber criteria such that the associated advertisements are inserted for the associated subscriber, the subscribers grouped by matching the predefined subscriber criteria with data provided by one or more modules of the data plane.

18. The advertising system of claim 1 wherein one of the management modules is a campaign module for associating digital advertisements with groups of subscribers according to predefined scheduling criteria such that the associated advertisements are inserted for the associated subscriber, the subscribers grouped by matching the predefined scheduling criteria with data provided by one or more modules of the data plane.

19. The advertising system of claim 1 wherein one of the management modules is an insertion module for scheduling playing of advertisements in the system according to instructions provided by one of the modules in the management plane.

20. A method of digital advertising in a cable system, the method comprising:
configuring a data plane having a plurality of data modules for storing data regarding digital advertisements;
configuring a control plane having a plurality of control modules for providing digital services to cable system subscribers;
configuring a management plane having a plurality of management modules for managing insertion of digital advertisements; and
controlling interaction of the modules according to an open-interface protocol such that the modules are operable with each other if one or more of the modules are provided by different vendors.
